(19) United States
(12) Patent Application Publication
(10) Pub. No.: US 2004/0085222 A1
(43) Pub. Date: May 6, 2004

(54) Remote control traveling device

(76) Inventor: Hideyuki Yoshikawa, Kanagawa (JP)

Correspondence Address: Satoru Takeuchi, Kanesaka & Takeuchi, 1423 Powhatan Street, Alexandria, VA, 22314, US

(21) Appl. No.: 10/297,258

(22) PCT Filed: Jun. 5, 2001
(86) PCT No.: PCT/JP01/04749

(30) Foreign Application Priority Data
Jun. 5, 2000 (JP) 2000-167043
Sep. 1, 2000 (JP) 2000-264821

(51) Int. Cl. G08C 19/00; G08C 19/12; H04L 17/02

(52) U.S. Cl. 340/825.69; 340/825.72; 341/176

(57) ABSTRACT

A controller is provided with a joy stick for designating a direction for a traveling body to run in, and transmits a radio signal such as an infrared ray in a target direction (α), in which the joy stick is brought down. The traveling body receives the radio signal to acquire the target direction (α) and to detect the direction for the radio signal to come in, and determines a relative direction (β) of the traveling body with reference to the coming direction of the radio signal. Direction changing means is driven to align the directions (α and β) with each other so that the traveling body may travel automatically in the target direction. As the player merely brings down the joy stick in the direction for the traveling body to run, therefore, the traveling body runs in the direction so that the control is drastically simplified.

### FIELD OF THE INVENTION

The present invention relates to a device which uses a radio signal for remotely controlling a variety of running models, game machines, pet robots and other toys, or running objects in home robots, carrying robots, dangerous working robots, welfare equipments, and the like.

### BACKGROUND ART

A number of remote controlled devices have been produced, being in wide spread use, especially for toys, however, with almost all of them, the controller equipped with a steering lever and a speed lever for running forward and backward is operated; the data for running speed and amount of steering that is inputted with the controller is transmitted as a radio signal; and the running object receives it, and drives the steering device and running device in accordance with the received data.

In other words, the conventional remote controlled device is nothing but a device with which the control itself inside a running object has been brought to a far place with a radio signal.

Therefore, the operator controls the running object with a feeling as if he or she were in the running object, but visually with a feeling of objectively looking at the running object from a far place, thus the controlling is performed while involving a discrepancy between the feeling in control and the vision.

Therefore, for maneuvering the running object, the operator must have been well trained to such a degree that he has got a special sensory function to eliminate the above-mentioned discrepancy, thus for average persons, the control is extremely difficult.

For example, the rightward and leftward handle operation to be made when the running object is pulling away from the operator is completely inverse to that when it is returning to the operator, and from this, the difficulty could be understood.

A solution to this problem is to load a television camera on the running object for transmitting the image with a radio signal such that the operator displays the image from the camera on the monitor screen while operating the controller to transmit the instruction to the running object, i.e., to transfer the vision into the running object for elimination of the discrepancy between the vision and the control, however, this solution requires a large-scale device.

The present invention is intended to facilitate the control by making the way of control objective to match it to the vision rather than changing the vision.

### DISCLOSURE OF THE PRESENT INVENTION

FIG. 46 is a schematic block diagram illustrating the present invention. A controller 1 is provided with orientation control means 170 and running control means 171, and specifically, a joystick or the like used with television game machines is employed as the orientation control means 170 to input the target orientation angle α by the direction of throwing down the joystick.

The running control means 171 makes start and stop of the running object, switches between the forward running and the backward running, and specifies the speed, and it may be a switch, a potentiometer equipped with a lever, or any other device. Further, the running control means 171 also involves such information as that about whether the joystick is thrown down or not. All the information is read by the microprocessor, and the target orientation angle α and the running signal are emitted as a radio control signal. Further, an unmodulated radio signal is emitted as a signal for incoming direction detection for a definite period of time. To these, control other than that for running is added, but the description is omitted.

A running object 2 comprises means for receiving a control radio signal and decoding it to obtain a target orientation α and a running signal, and a radio signal incoming direction detecting means 174, which receives a radio signal and detects the incoming direction θ. If the radio signal incoming direction θ is known, an orientation angle calculation 175 makes a simple operation to give the relative orientation angle for the running object, using the line connecting between the controller 1 and the running object 2 as the reference.

After obtaining the target orientation angle α included in the control signal, driving orientation changing means 176 for the running object with the use of (α−β) will turn the running object, if α is different from β, and as the running object is turned, β is approached to α until α=β, when the running object is stopped. In other words, the running object is always automatically controlled such that it is directed to the target orientation α. This is due to an implicit feedback as shown with a dotted line in the figure being provided. At the same time, the running signal drives running means 177. Thus, the running object combines the orientation change with the run to provide normal running.

Here, if the target orientation signal a is tuned with the direction in which the control lever is thrown down, the running object will move forward, being directed toward the direction in which the control lever is thrown down, thus the present invention assures extremely comprehensive control. However, it is essential that the controller 1 be directed toward the

A running object 2 in tuning, as shown in FIG. 1. For running objects, two different types of running schemes are used; one of them is a scheme which provides right and left driving wheels which are independent of each other. In this case, the rotation of the right and left wheels in the same direction provides running means, while that of the right and left wheels in the reverse direction gives changing means. This scheme also allows turning operation in the place, thus the previous account holds true.

The other scheme mechanically separates the steering from the running, as is the case with cars and ships. In this case, the steering provides orientation changing means, while the driving wheels give running means. However, with this scheme, the steering will not change the orientation of the running object unless the running is being given.

However, both schemes are essentially the same, except for whether or not the running is a prerequisite for steering.

A unique feature of this remote control system is that the absolute orientation is not used. In other words, the reference for orientation is the direction of the line connecting between one point of the controller emitting a radio signal and the incoming direction detector of the running object to be controlled.

Next, the block diagram as shown in FIG. 45 will be described. FIG. 47 illustrates an embodiment which provides practically the same function as that for the embodiment as illustrated in FIG. 46, but has a slightly different configuration. Specifically, the radio signal incoming direction detecting means itself in FIG. 47 has a directional characteristic, and is configured such that the directional characteristic can be changed by controlling that means with the target orientation angle α.

When the radio signal incoming direction detecting means 174b has a directional characteristic at a certain angle, and the output is calculated and applied to orientation changing means 176 for the running object, the orientation for the running object 2 is driven to be turned and stopped at a certain direction. Then, if the received target orientation α can be used to provide a proper control of the directional characteristic, the running object will run, being always directed toward the received target orientation α, as is the case with the embodiment as illustrated in FIG. 31.

The embodiment as illustrated in FIG. 46 is qualitative, being easier to be comprehended, and that as illustrated in FIG. 47 can be considered to be a variant of that in FIG. 46, thus hereafter only the block diagram as shown in FIG. 46 will be used for discussion.

Radio signals include electric wave, light beam, and ultrasonic wave, and any of these can be used, if the incoming direction can be detected, however, light beam and infrared ray can be used most conveniently.

Use of electric wave for detection of the incoming direction has conventionally been carried out as a navigation for ships, however, for compactness, electric wave having a high frequency is required.

### BRIEF DESCRIPTION OF THE DRAWINGS

FIG. 1 is a top view of an embodiment of the present invention;

FIG. 2 is a plan view of a controller 1;

FIG. 3 is a front view of the controller 1;

FIG. 4 is a plan view of a running object;

FIG. 5 is a side view of the running object;

FIG. 6 is a block diagram of the controller 1;

FIG. 7 is a block diagram of the running object 2;

FIG. 8 is a waveform diagram for signals for respective portions, (a) providing a description of the contents of the signals, (b) showing a signal before modulation in the controller 1, (c) showing a signal after modulation, (d) showing a waveform received by the running object 2, and (e) showing a demodulated waveform of (d);

FIG. 9 shows sensitivity characteristics of four light receiving elements for light-receiving angle;

FIG. 10 shows characteristics of V(n)/V(m) for light-receiving angle;

FIG. 11 is a plan view of light receiving elements with angle;

FIG. 12 shows a Vrot characteristic for error angle;

FIG. 13 shows a Vrot characteristic for error angles expanded to 360° or more;

FIG. 14 is a flowchart for angle expansion;

FIG. 15 is an initial running locus drawing;

FIG. 16 is an initial running locus drawing for a car type running object;

FIG. 17 is a flowchart for orientation changing for a car type running object;

FIG. 18 is a running status chart for the running object 2;

FIG. 19 is a top sectional view of a light receiving element in the light-receiving state;

FIG. 20 is a diagram showing the relationship between light-receiving angle of light-receiving element and output;

FIG. 21 is a perspective side view of another embodiment of controller;

FIG. 22 is a block diagram for the controller in FIG. 21;

FIG. 23 to FIG. 25 illustrate embodiments of joy stick operation and running of the running object 2;

FIG. 26 shows a ray incoming direction sensor having a sensitivity to a signal coming from above that is added to the light receiving elements;

FIG. 27 and FIG. 28 illustrate embodiments of detecting the incoming direction at an elevation angle;

FIG. 29 and FIG. 30 illustrate embodiments in which different infrared rays are outputted from two points on the controller for distance search;

FIG. 31 shows the waveforms of the infrared rays in the embodiments as illustrated in FIG. 29 and FIG. 30;

FIG. 32 illustrates an embodiment in which different infrared rays are outputted from three points on the controller;

FIG. 33 shows the waveforms of the infrared rays in the embodiment as illustrated in FIG. 32;

FIG. 34 is a top view of an embodiment in which three running objects are connected to be controlled;

FIG. 35 is a timing chart for the control signals in the embodiment as illustrated in FIG. 34;

FIG. 36 is a top view of an embodiment of running object, 2k, having a working base;

FIG. 37 is a side sectional view of the same;

FIG. 38 is an operation explanatory drawing for the running object 2k having a working base;

FIG. 39 illustrates an embodiment of running object using infrared ray for angle detection of the working base;

FIG. 40 illustrates an embodiment of running object equipped with second incoming direction sensors for angle detection of the working base;

FIG. 41 to FIG. 43 are conceptual diagrams for embodiments of remote controlling using a communication line;

FIG. 44 is an operation explanatory plan view of a controller having binoculars;

FIG. 45 is a side view of the same;

FIG. 46 is a block diagram illustrating the present invention; and

FIG. 47 is a block diagram of a special embodiment of the present invention.

### BEST ASPECTS TO EMBODY THE INVENTION

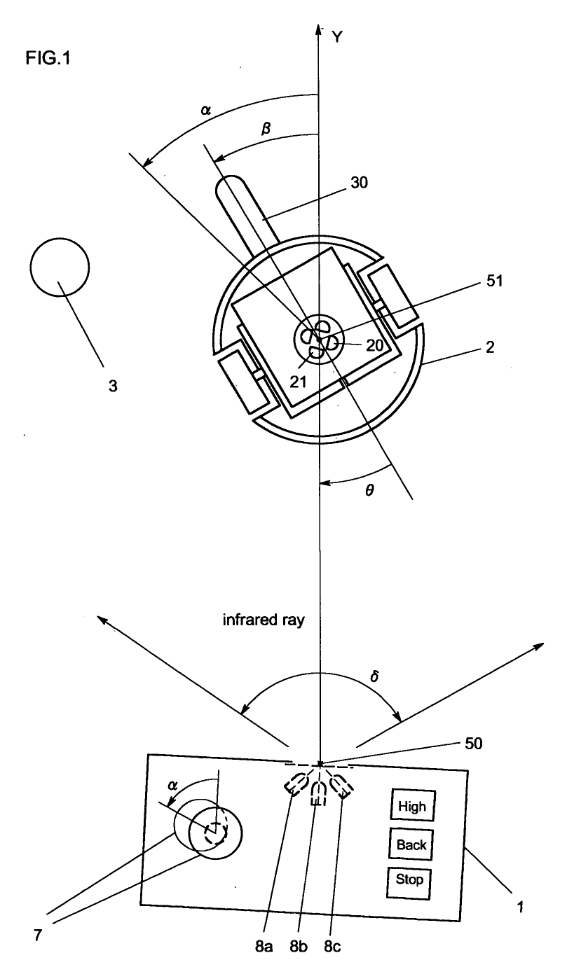

FIG. 1 is a top view of an embodiment of the present invention, showing the relationship among a controller 1, a running object 2, and a ball 3.

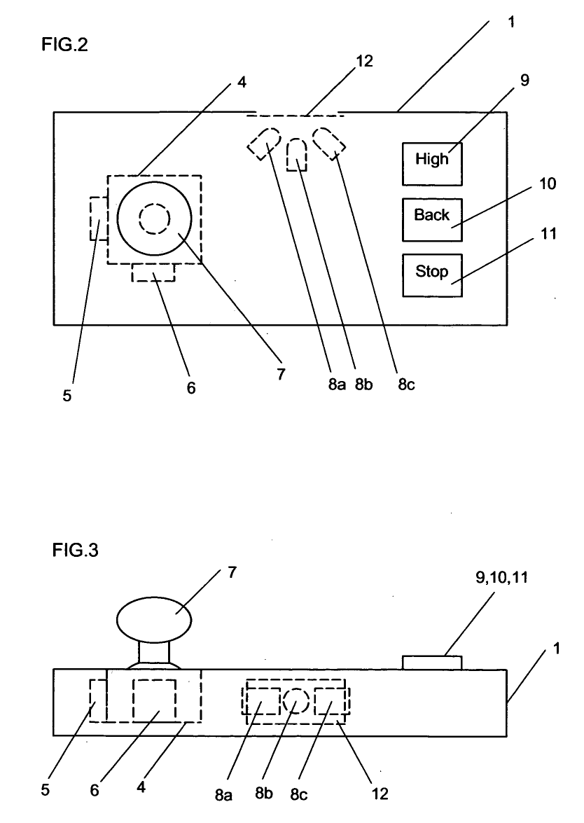

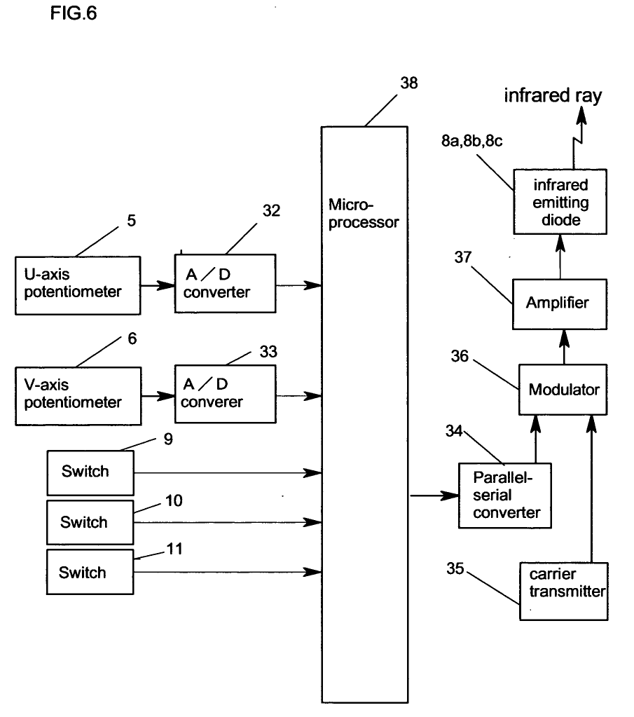

First, the controller 1 will be described. FIG. 2 and FIG. 3 are a plan view and a front view, respectively, showing the appearance of the controller 1. FIG. 6 is a block diagram.

The mechanism portion 4 of a joystick 7 is equipped with a potentiometer 5 for detecting of U-axis turn and a potentiometer 6 for detecting of V-axis turn. In accordance with the direction in which the joystick 7 is thrown down, the position of the contact of the potentiometer is moved. By connecting a positive voltage and the ground potential to the terminals of the potentiometer, and connecting the sliding point to an A/D converter 32, 33 for reading the voltage, the turning angle for U, V is determined, and by converting this angle using the inverse trigonometric function, the direction in which the joystick 7 is thrown down can be read as an angle.

A pushbutton switch 9 is a switch to increase the running speed, a pushbutton switch 10 is a switch to instruct backward running, and a pushbutton switch 11 is a switch to stop running.

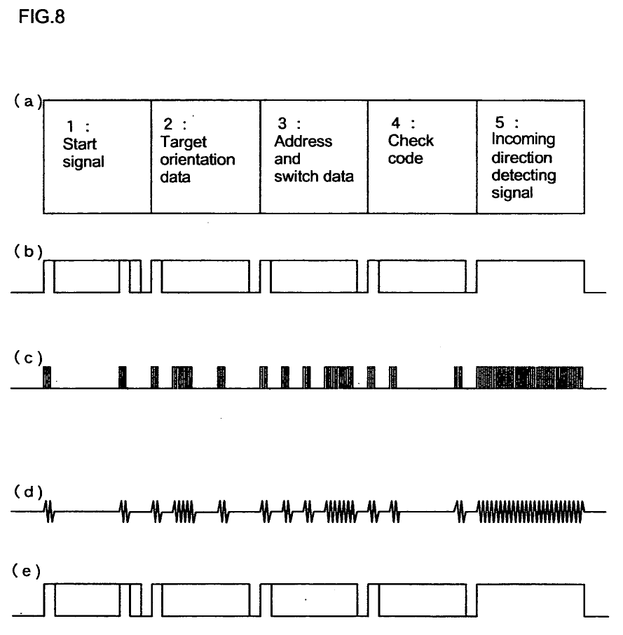

A microprocessor 38 sends out the inputs from these switches as control data to a parallel serial converter 34 dozens of times per second. A carrier transmitter 35 transmits a carrier at a frequency of 455 kHz, and the carrier is ASK-modulated by a modulator 36, amplified by an amplifier 37, applied to a light emitting diode 8a, 8b, 8c, and sent out therefrom as an infrared ray. FIG. 8 shows the waveforms for these. Further, the three infrared light emitting diodes 8a, 8b, and 8c are disposed at different angles as shown in FIG. 2, and are arranged so as to be able to radiate infrared ray through a small infrared ray permeating window 12, expanding the irradiation width angle to δ in the horizontal direction. Further, the luminous flux passes in the vicinity of an emission center point 50.

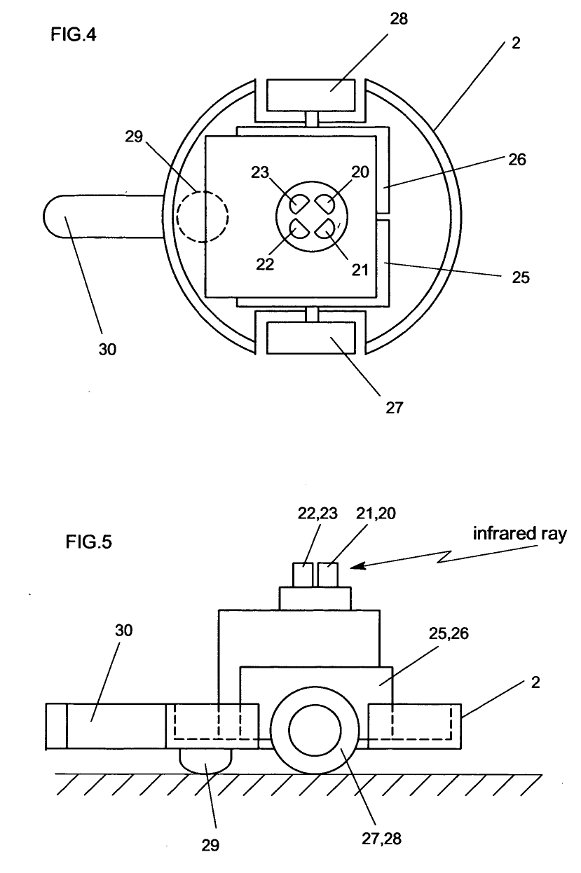

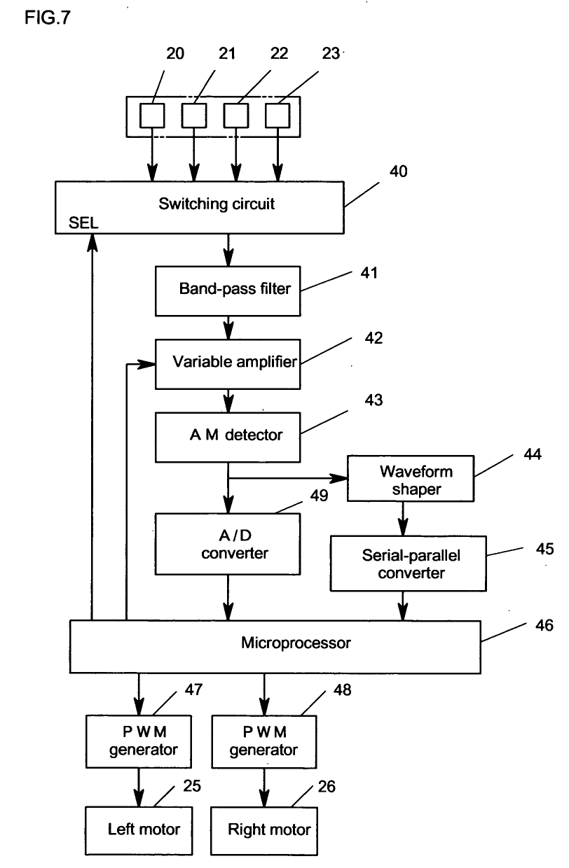

FIG. 4 and FIG. 5 are a plan view and a side view, respectively, of the running object 2, and FIG. 7 is a block diagram for it. Four light receiving elements 20, 21, 22, 23 are arranged on a circle on top of the running object 2, the light receiving surfaces thereof being faced toward the outside. The outputs thereof enter a switching circuit 40 in FIG. 7, and a signal selected with a selection signal from a microprocessor 46 enters the next band-pass filter, where the required signal is sifted out and then enters a variable amplifier 42. The variable amplifier 42 comprises a multi-stage switch and a number of resistors and amplifiers, and the amplification factor is controlled by a signal from the microprocessor 46. The output of the variable amplifier 42 enters an AM detector 43 and, after being detected, enters an A/D converter 49, where the voltage is readout. This signal α1 so enters a waveform shaper 44, where it is converted into a digital signal, and is converted by a serial-to-parallel converter 45 into a parallel signal to be read by the microprocessor 46 as the received data.

Here, the operation will be described with reference to the waveform diagrams in FIG. 8(a) to (e). The controller 1 generates the signals as shown in FIG. 8(a). The 1: start signal is a code for indicating the beginning of a block. The 2: target orientation data provides an orientation angle corresponding to the direction in which the joystick is thrown down. The 3: address and switch data includes the addresses for identifying a plurality of running objects, information about whether the switch 9, 10, 11 has been pressed or not, and information about whether the joystick 7 has been thrown down or not. The 4: check code is a code for determining whether the received data is correct or not. In this case, horizontal and vertical parities are used. The 5: signal for detecting the incoming direction provides a signal for determining the orientation of the controller 1 on the side of the running object 2 and is transmitting an unmodulated carrier of one character time.

FIG. 8(c) shows a signal applied to the light emitting diode 8a, 8b, 8c of the controller 1, and FIG. 8(d) shows the waveform after being passed through the light receiving element of the running object 2, and the band-pass amplifier 41 or the variable amplifier 42. FIG. 8(e) shows a waveform outputted from the waveform shaper 44 after being detected.

Next, the operation of the running object 2 after it receives a signal as shown in FIG. 8 will be described. The four light receiving elements 20, 21, 22, and 23 convert the received light into a voltage and send it to the switching circuit 40. In the initial status, the switching circuit 40 receives a switching signal from the microprocessor for scanning. The variable amplifier 42 is at a maximum sensitivity. If the light receiving element which receives the infrared ray signal is selected, a reception signal is generated, and it passes through the band-pass filter 41, the variable amplifier 42, and the waveform shaper 44. Then the waveform as shown in FIG. 8(e) enters the serial-to-parallel converter 45 and is read into the microprocessor 46 as a parallel signal string. The received block is error-checked, and if it is found to be error-free, the incoming direction is detected.

First, the output of the AM detector 43 is read by the A/D converter, while the switching circuit 40 is scanned. The amplification factor of the variable amplifier 42 is determined such that, even when the light receiving element which provides a maximum output is selected, the amplifier is in the linear area and the maximum output is provided.

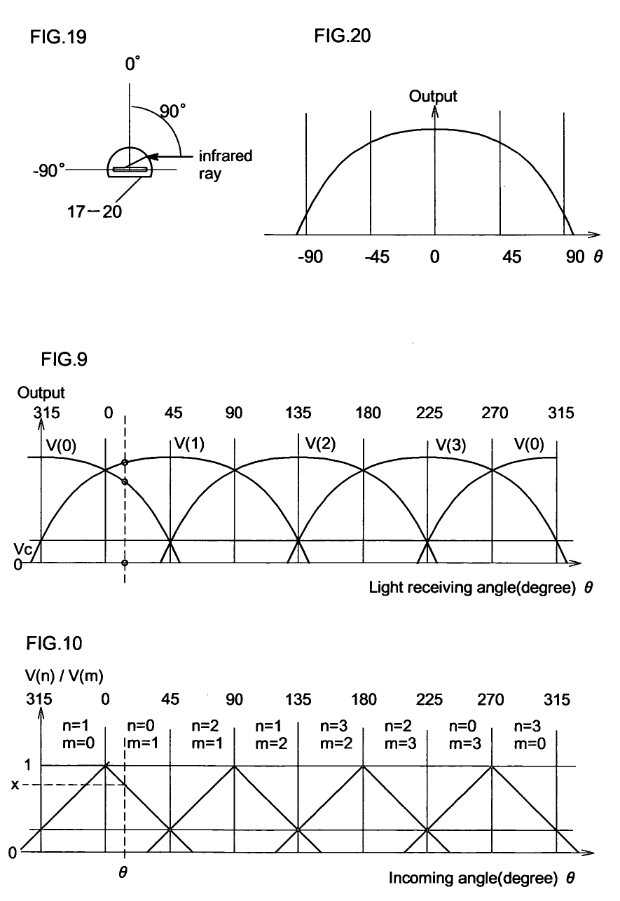

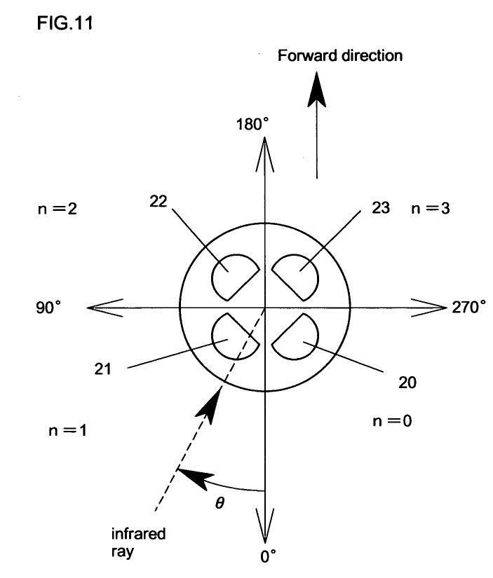

Then, with the amplification factor of the variable amplifier 42 being maintained at a constant value, the switching circuit 40 is sequentially scanned, and the outputs of the four light receiving elements are read by the A/D converter 49. The orientation of the light receiving surface of the light receiving element which provides the maximum output among the four light receiving elements roughly indicates the incoming direction. Next, correction is made to determine the exact angle. The V(0), V(1), V(2), and V(3) in FIG. 9 are actually measured curves for output value divided by light receiving angle of the light receiving elements 20, 21, 22, 23, respectively, where a light receiving angle θ is defined as shown in FIG. 11.

From the characteristics as shown in FIG. 9, drawing a graph of the ratio of V(m) to V(n), i.e., V(n)/V(m), where V(m) and V(n) are the values of the highest and next highest outputs for a given value of light receiving angle, θ, gives a result which is approximately as shown in FIG. 10.

Here, Let's assume that, at a certain moment, V(1) is the maximum voltage and V(0) is the next highest voltage. From FIG. 9, it can be found that the light receiving angle falls between 0° and 45°. By calculating the value of x=V(0)/V(1) and applying it to the graph in FIG. 10, the exact light receiving angle or incoming angle θ is determined. However, the graph as shown in FIG. 10 must be previously computed and stored in the ROM as data. Further, in FIG. 11, the direction of 180° is the forward direction for the running object 2.

As a supplementary description of the characteristics of the light receiving element, the light receiving elements 21 to 23 are D-shaped in section as shown in FIG. 19, and therefore can provide a normal sensitivity even when the infrared ray shines from the side as shown in FIG. 19. In other words, they can continuously provide the sensitivity characteristic as shown in FIG. 20 over a span exceeding 180° about the 0° axis in FIG. 19. Therefore, with a sensor equipped with four light receiving elements, with which the orientations of any two adjacent ones are different by 90°, two or more light receiving elements of the four can simultaneously provide outputs regardless of the incoming direction, and from the ratio of one to another, the incoming angle can be determined. The flat surface type light receiving element cannot do the same because it has no sensitivity to the infrared ray shining from the side.

Next, the function will be comprehensively described. Let's assume that, in FIG. 1, the joystick on the controller 1 is thrown down in the direction at an angle α of the forward direction. From the controller 1, the signals as illustrated in FIG. 8 are being continuously transmitted, and in this case, the signals are transmitted as the 2: target orientation data α in FIG. 8, and one of the 3: switch data is turned on as a run command. Then, all data in FIG. 8 is sent out.

Upon receiving these signal, the running object 2 performs address checking and data error checking and, if the address and data are correct, the running object 2 receives the signal for detecting the incoming direction and determines the incoming angle θ.

The Y axis in FIG. 1 is a line connecting the infrared ray emission center point 50 of the controller 1 with the light receiving center point 51 of the light receiving elements of the running object 2. Therefore, the Y axis is not a fixed axis but is moved along with the controller 1 or the running object 2.

Here, if the orientation of the running object 2 with respect to the Y axis is β, it is as illustrated in FIG. 1, and if β and θ are defined as illustrated in FIG. 1, β=θ. Because the target orientation angle is a which has already been received, the error angle E=α−β, and the orientation of the running object 2 is controlled such that the value of E is reduced.

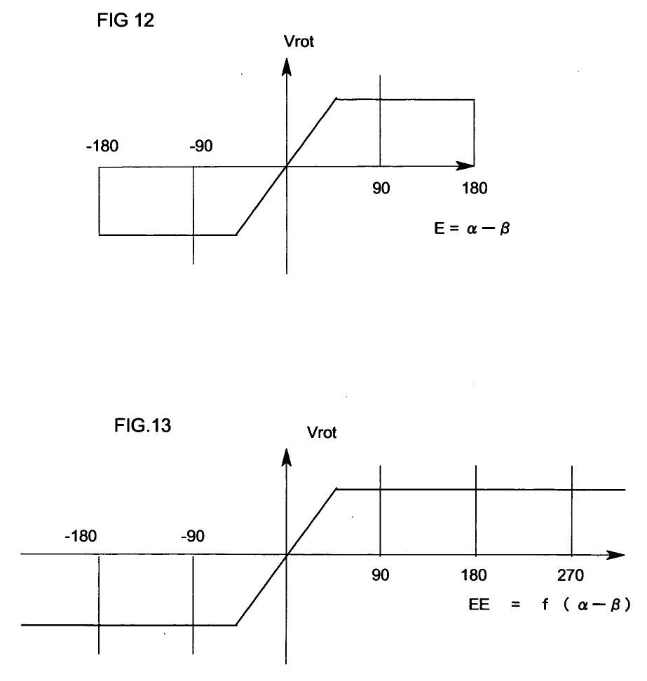

Here, for providing such control, the following correction is carried out. When (α−β)≧180°, the value of (α−β) is corrected so as to be equal to (α−β−360°), and when (α−β)<−180°, the value of (α−β) is corrected so as to be equal to (α−β+360°). By doing this, the value of (α−β) will meet the expression of −180≦(α−β)<180. By passing the function as shown in FIG. 12 with the use of the microprocessor, the voltage for orientation control, Vrot, is obtained.

This voltage is used to provide orientation change drive. In other words, Vrot is applied to the motor to drive the right wheel, and −Vrot is applied to the motor to drive the left wheel through PWM signals.

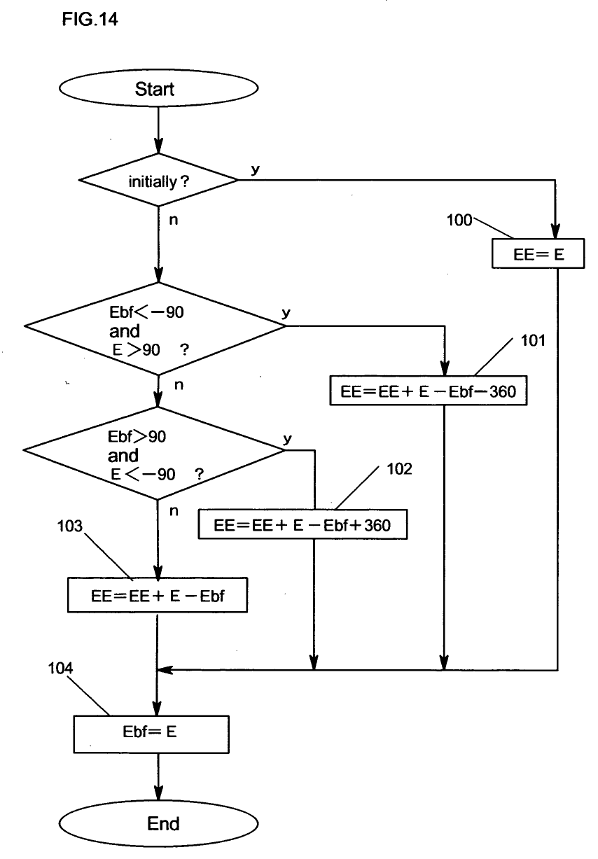

Further, the following matter is taken into consideration. If the joystick is turned at a speed higher than the response speed of the running object 2, the error angle may excess +180° or −180°. To solve this problem, the span of E=α−β is expanded to 360° or over and converted into EE, utilizing the continuity of (α−β) and applying the algorithm as illustrated in the flow chart in FIG. 14. Ebf is the variable representing the previous E.

Before the expansion, the error angle E falls within the range of −180° to +180°, as shown in FIG. 12. If the value of E exceeds this range, for example, if E is increased by 30° from 170°, E will exceed the discontinuity point and be −160°, instead of the correct value of 200°, if no corrections are given.

When the algorithm for angle expansion in FIG. 14 is applied,

(1) initially

EE=E=170; 100 in FIG. 14

Ebf=E=170; 104 in FIG. 14

(2) When increased by 30°,

Since Ebf=170>90

and E=−160<−90,

$$EE = EE + E - Ebf + 360 ; 102 in FIG . 14 \\ = 170 + ( - 160 ) - 170 + 360 \\ = 200$$

This shows that the original error angle E is changed into EE, being expanded to a span of 360° or more. FIG. 13 shows the voltage for orientation control, Vrot, plotted using the expanded error angle of EE.

In this figure, f(E) is the function for expanding E to 360° or more.

Thus, it is possible to allow the running object 2 keeping up with a joystick operation that is faster than the orientation-changing ability of the running object 2.

Now the orientation control will be connected with the run control. If the voltage representing the forward running speed is Vfwd, a PWM voltage corresponding to Vfwd−Vrot is applied to the left motor 25, and a PWM voltage corresponding to Vfwd+Vrot is applied to the right motor 26.

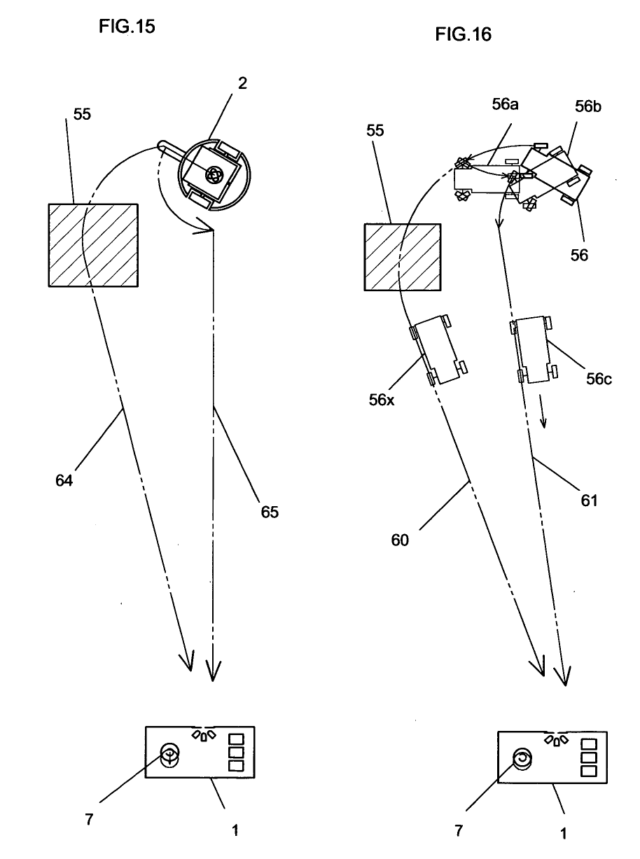

Next, the concept of improved run at the time when the running is started from the stopped status will be described. In FIG. 15, let's assume that the running object 2 is at standstill in the state as shown in the figure. If the joystick 7 is thrown down to the front and the running object 2 is caused to provide normal run, the running object 2 first runs in a circle, because the running locus is determined by the combination of the forward run (Vfwd>0) with the rotation (Vrot), and, when the target orientation is approached, the run is changed over from the normal run to the linear run, a locus such as a locus 64 being traced. Therefore, in the presence of an obstacle 55, the running object 2 will hit it against the intention of the player, preventing the player from controlling the running object 2 as desired. To eliminate this problem, the running object 2 has been adapted to turn in the initial location with the running speed Vfwd being set at 0 at the initial stage of run, and to start the normal run when the orientation has approached the target one. This allows the running object 2 to run in a compact locus like a locus 65 as shown in FIG. 15.

Next, an embodiment of the present invention for a structure like a car in which the running object changes the orientation by combining the steering operation with the run will be described. Let's assume that a car type running object 56 in FIG. 16 is under control with a controller 1. In the normal run, the car type running object 56 is first steered to the left to provide left curve running, as indicated with a locus 60, and then starts the linear run when the target orientation is approached. In this case, the first curve causes the car type running object 56 to hit the obstacle 55.

With an algorithm for changing the orientation at the initial stage of run, steering left causes forward running, and after running a certain distance (to a position of 56a), steering right causes backward running (to a position of 56b), then, steering left causes forward running, the locus 61 being traced, which allows the destination to be reached without hitting the obstacle.

FIG. 17 is a flow chart for changing the orientation of the car type running object. First, whether or not the target orientation and the orientation of the running object are close to each other is determined in the step 101. If they are close to each other, the step is moved to return, and the run is changed over to the normal run. Otherwise, which direction of turn gives a shorter course is examined in the step 102. The figure shows only the case in which left turn gives a shorter course, however, for right turn, the procedure is the same except for the direction of turn. First, steering left gives forward running in the step 103. The angle of turn is examined in the step 104, and after turning through a certain angle, steering right causes backward running. Then, after running again through a certain angle in the step 106, the step is returned to the original, and steering left gives forward running in the step 103, and the run is changed over to forward running. This procedure is continued to be repeated. At the same time, whether or not the orientation of the running object is close to the target orientation is being checked in the step 107, 108, and when the orientation of the running object is close to the target orientation, the step is moved to return, and the run is changed over to the normal run.

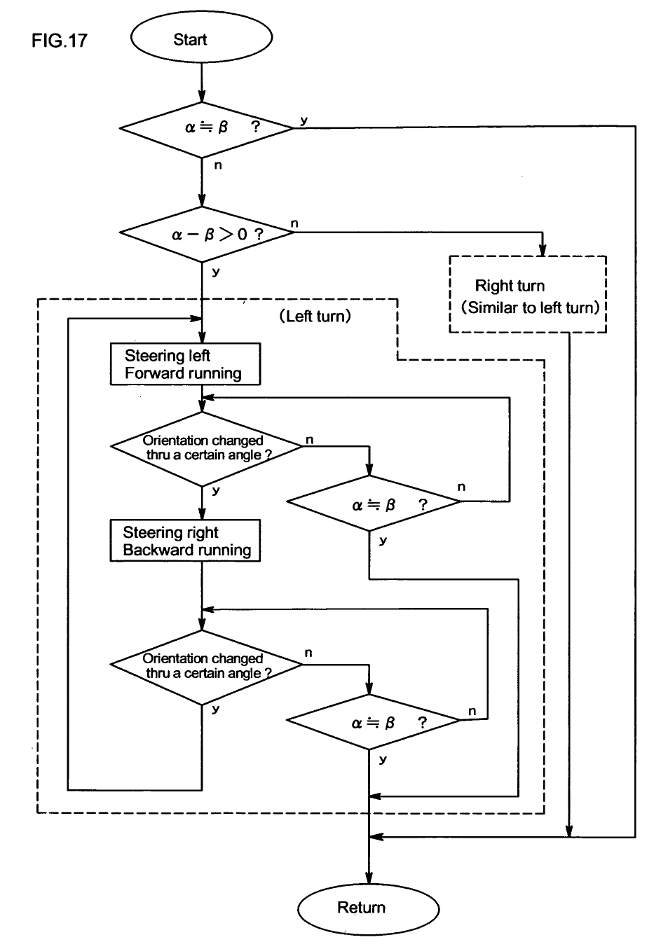

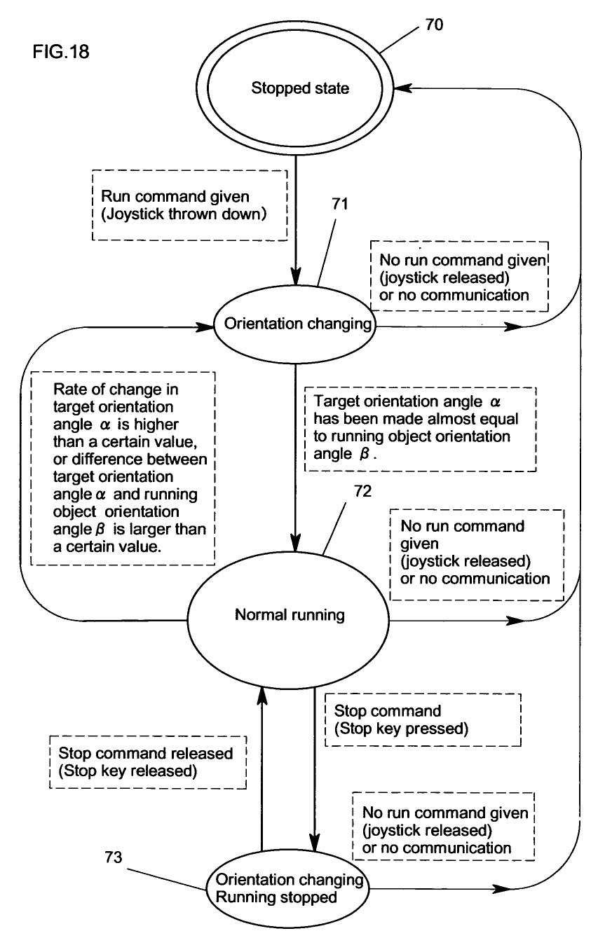

Here, the operation of the running object 2 will be described with reference to the status flowchart in FIG. 18. When the power is turned on, the running object 2 is in a stopped status 70. Let's assume that the joystick 7 of the controller 1 is thrown down. The signal contains the target orientation angle α and a run command. Upon the signal being received, the status is moved to the orientation changing 71. In this status, the turn is controlled such that the orientation angle of the running object 2 is close to the received target orientation angle α. When the target orientation angle α is equal to the orientation angle β of the running object 2, the status is moved to the normal running 72. In this status, the running object 2 runs while changing the orientation, following the change in the received data about the movement of the joystick 7, i.e., the target orientation angle α. Then, if the stop key 11 of the controller 1 is pressed, the running object 2 receives a signal containing a stop command, and the status is moved to the orientation changing—run stopped status 73. In this status, the run is stopped, but the orientation of the running object is changed, following the change in the data about the movement of the joystick 7, i.e., the target orientation angle α. The orientation of the running object is turned as desired to the joystick 7. Thus, if the ball 3 is near the running object 2, the running object 2 can be turned toward the ball 3 such that the hitting stick 30 hits the ball 3. This status continues as long as the stop key 11 is pressed. When the stop key 11 is released, the status is returned to the normal running 72 and the run is started. Then, when the stop key 11 is pressed again, the status is moved to the orientation changing—run stopped status 73, the run being stopped. In this status, the orientation can be carefully adjusted because the running object 2 is at standstill. By thus repeating the run and stop, it is possible to cause the running object 2 to run extremely accurately.

If the joystick 7 is turned suddenly through a large angle in the status of normal running 72, the target orientation angle α is abruptly changed. Or, a large difference is produced between the target orientation angle α and the orientation angle α of the running object 2. In such case, the status is moved to the orientation changing 71, the run being stopped, and the orientation being changed quickly. The running object 2 is turned until the target orientation angle α and the orientation angle β of the running object are equal to each other. Then, the status is again returned to the normal run 72, the run being continued.

Further, in any status, the joystick being released or the signal from the controller 1 being interrupted returns the status to the stopped status 70, the run being stopped.

Further, in the embodiment as illustrated in FIG. 1, a simulation soccer game machine in which the ball 3 is hit with the hitting stick 30 is assumed. If the stop key 11 is pressed with the joystick 7 being thrown down, Vfwd is zeroed, the running object 2 being stopped but the orientation control being still effective, and the running object 2 can be reoriented in the direction in which the joystick 7 is thrown down. When the running object 2 is controlled and stopped near the ball 3, turning the joystick 7 will turn the running object 2, and thus the ball 3 can be hit with the hitting stick 30. The direction in which the ball 3 is driven depends upon which side of the ball the running object 2 is positioned on and the direction in which the running object 2 is turned.

Because pressing the stop key allows the player to carefully turn the running object 2 in a desired direction, repeating the pressing and releasing of the stop key 11 will allow precise control to be made easily.

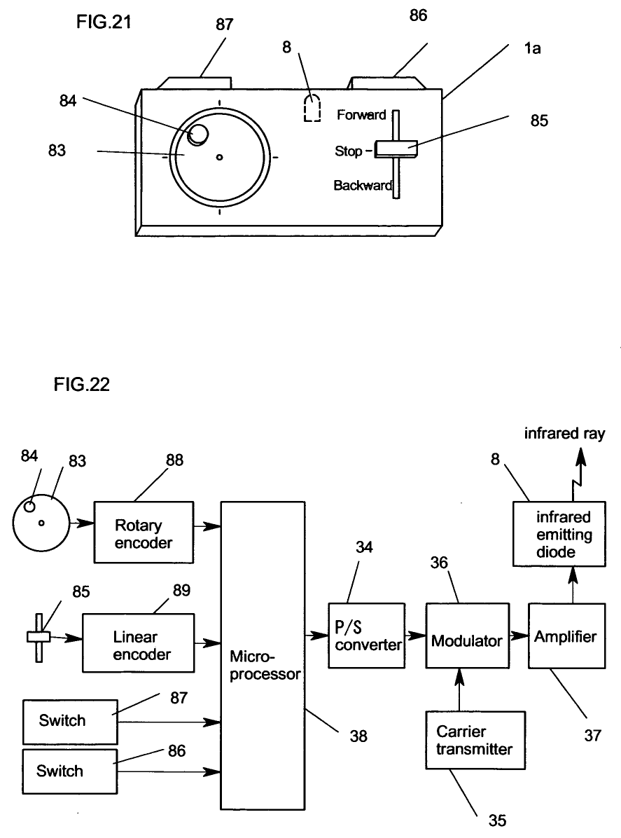

Next, another embodiment of controller, 1a, is shown in FIG. 21. This controller 1a uses a rotary encoder 88 for inputting a target orientation. The rotary encoder 88 has a knob 84, and by turning the knob 84, the target orientation angle α is inputted, and constantly transmitted. A linear encoder 89 having a sliding knob 85 is used to switch between the forward running and the backward running, and to change the speed. The sliding knob 85 is forced to be returned to the stop point at the middle by a spring. A switch 86, 87 is used to control the motors other than those for running that are mounted on the running object 2, and information from these switches is also constantly transmitted.

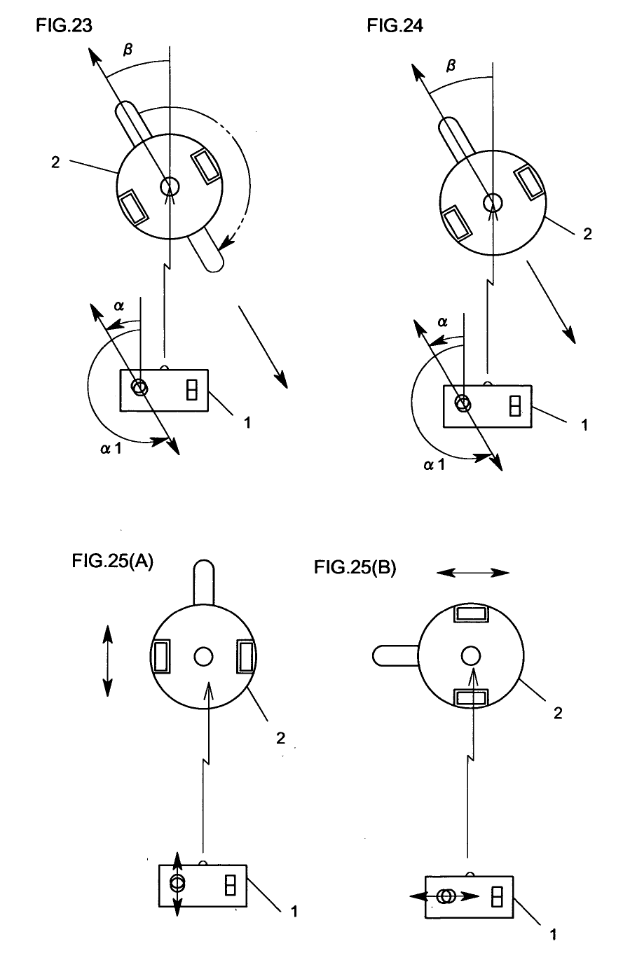

Next, an embodiment for switching between the forward running and the backward running will be described. The above description has mentioned a method which performs switch operation or speed lever operation of the controller 1 for switching between the forward running and the backward running. In this embodiment, such switching is made by operation of a joystick lever. In FIG. 23, which is for the mode described up to now, throwing down the joystick of the controller 1 to the direction of the target orientation angle α causes the running object 2 to run in the direction of β=α. Let's assume that the joystick is returned to the neutral position once, and then thrown down in the opposite direction, i.e., the direction of α1. Then, the running object 2 is stopped once, and then turned through 180° in the place, starting running in the direction of α1.

A new mode will now be described. In this mode, before the running object 2 starts running from the stopped status, it examines the relationship between the current orientation angle β and the received target orientation angle α. Then, if the absolute value of the difference between α and β is less than 90°, the running object 2 is moved forward, while, if the value is greater than 90°, the running object 2 is moved backward. This mode of switching between the forward running and the backward running allows the player not only to change the running direction but also switch between the forward running and the backward running by merely operating the joystick. An embodiment of this mode is shown in FIG. 24. In this embodiment, if the joystick is thrown down in the direction of the target orientation angle α, the running object 2 is moved forward because ⊕α−β⊕<90°. On the other hand, if the joystick is thrown down in the direction of α1, the running object 2 is run backward in the direction of α1 because |α1−β|>90°.

This holds true for any value of α and β. Therefore, when the running object 2 and the controller 1 are aligned with each other, as shown in FIG. 25a, moving the joystick back or forth provides switching between the forward running and the backward running. When the running object 2 and the controller 1 are perpendicular to each other, as shown in FIG. 25b, moving the joystick sideways provides switching between the forward running and the backward running. This can be intuitively comprehended, thus assuring ease of operation. However, which mode is easier to use, and thus to be selected depends upon the particular application.

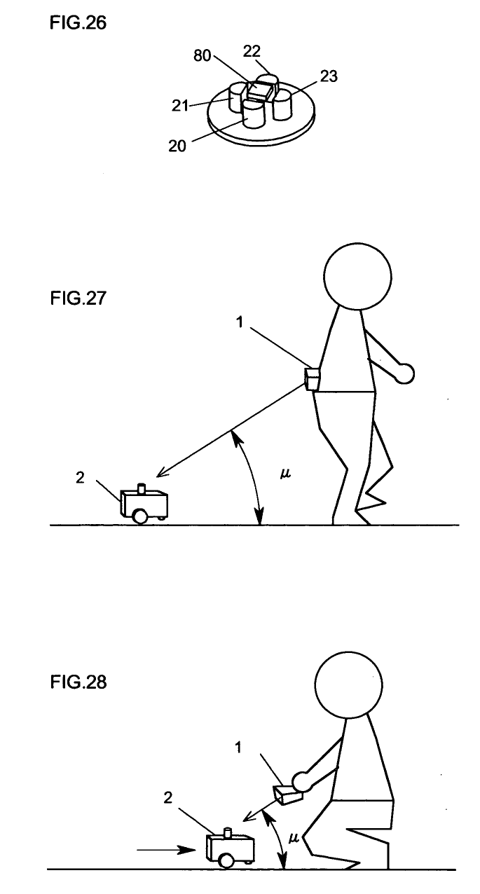

FIG. 26 illustrates an embodiment in which a light receiving element 80 having a sensitivity to a signal coming from above is added to the light receiving elements 20, 21, 22, 23, which are arranged to have a sensitivity in the horizontal direction. In this embodiment, not only the amount of light received in the horizontal direction but also that of light received in the vertical direction can be detected. Therefore, if the controller 1 is positioned above the running object 2, as shown in FIG. 27, the running object 2 can determine the elevation angle μ by determining the ratio of one of both amounts of received light to the other. By controlling the speed such that the elevation angle μ is maintained at a constant value, it is possible to cause the running object 2 to follow a person at a constant distance, as shown in FIG. 27, if the joystick on the controller 1 is kept pulled toward the front. If a person carrying the controller 1 squats down, as shown in FIG. 28, the running object 2 will automatically approach the person, because the elevation angle μ is controlled for a constant value. This concept is effective when applied to pet robots.

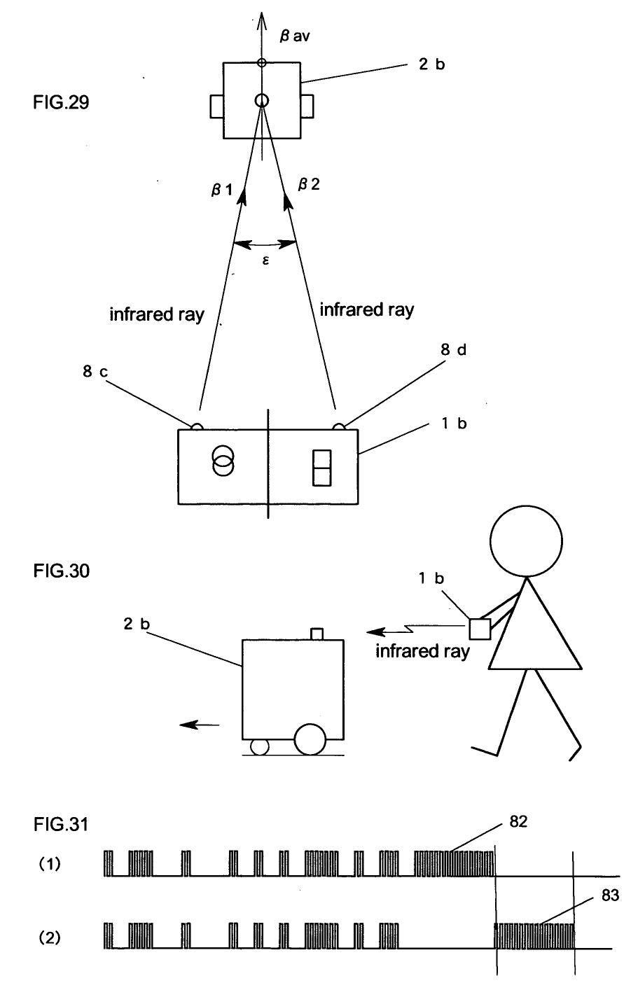

FIG. 29 illustrates an embodiment in which light emitting elements 8c, 8d are provided at both ends of a controller 1b in order to radiate infrared ray from both. The signals to be radiated are signals 82 and 83 for detecting the last incoming direction, which are different in timing as shown in (1) and (2) in FIG. 31. Upon receiving these signals, a running object 2b performs checking the normal control signals for reception error, and then receives the signals for detecting the incoming direction, and identifies the incoming directions of the two signals on the timings therefor, providing β1 and β2. It is possible to control the running object 2b so as to run at a constant distance from the player by not only controlling the orientation of the running object 2b using the mean value βav=(β1+β2)/2 as the incoming direction, but also controlling the running speed using ε=β1−β2 instead of the distance.

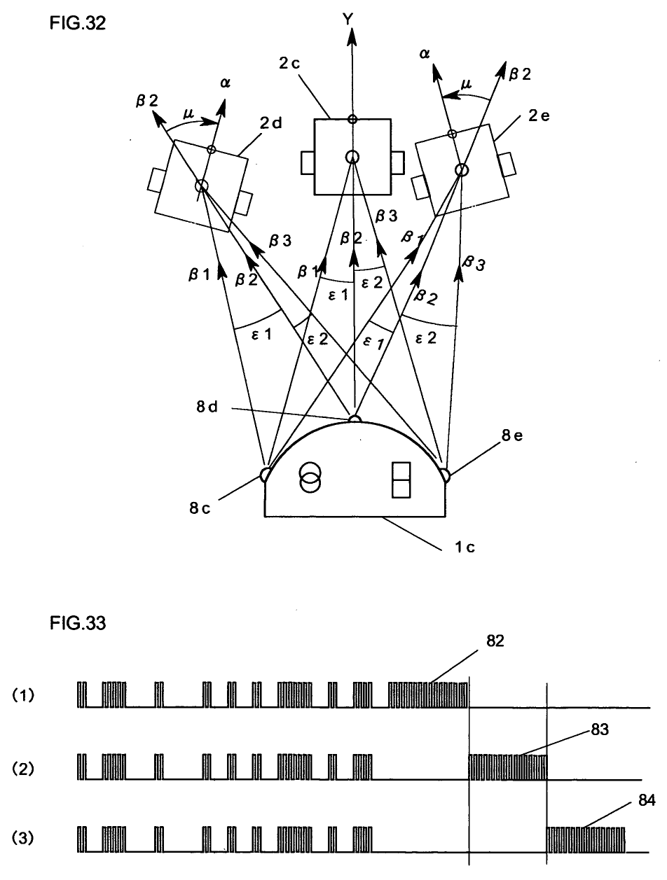

Further, an embodiment in which three light emitting elements 8c, 8d, 8e are provided on a controller 1c is shown in FIG. 32. If the signals for detecting incoming direction in the signals which are sent to the three light emitting elements are different in timing, as indicated by 82, 83, and 84 in (1), (2), and (3) in FIG. 33, the running object 2c can determine the incoming directions β1, β2, and β3 from the three light emitting elements. When the three angles β1, β2, and β3 are determined, the relative position of the running object 2c with respect to the controller 1c is determined, and therefore various types of control can be carried out. For example, if ε1=β1−β2 and ε2=ε2−ε3, the target orientation α=β2+μ, as shown in FIG. 32, where μ is the function of ε1 and ε2. When a running object 2c is directly in front of the controller 1c, μ=0 and therefore α=β2, meaning that they are in line. When the running object is deviated to the left as indicated by 2d, μ is increased, the target orientation α being changed to the right. By contrast, when the running object is deviated to the right as indicated by 2e, g is decreased, the target orientation α being changed to the left. This configuration makes it possible to create a system in which the running object is automatically controlled to keep running directly in front of the player.

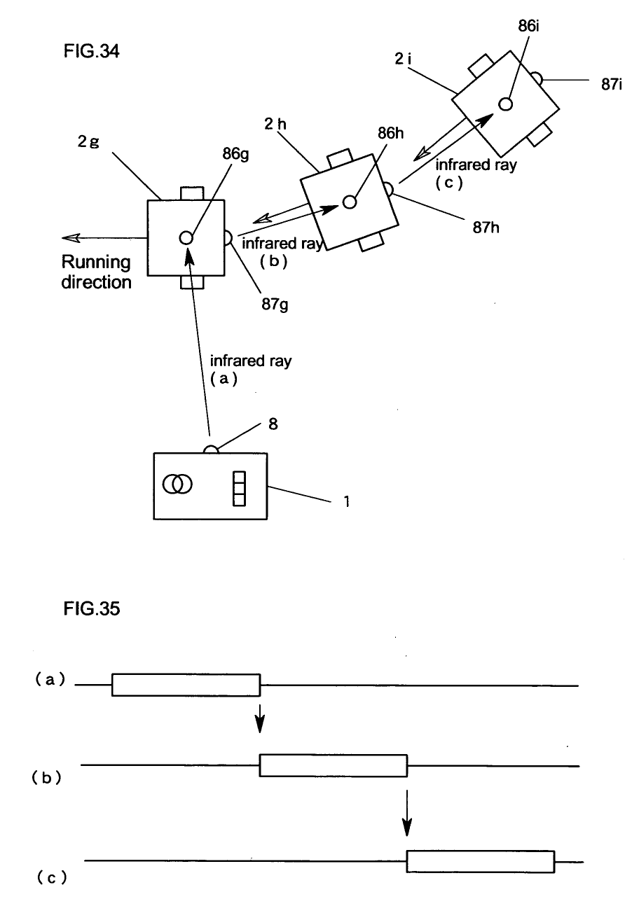

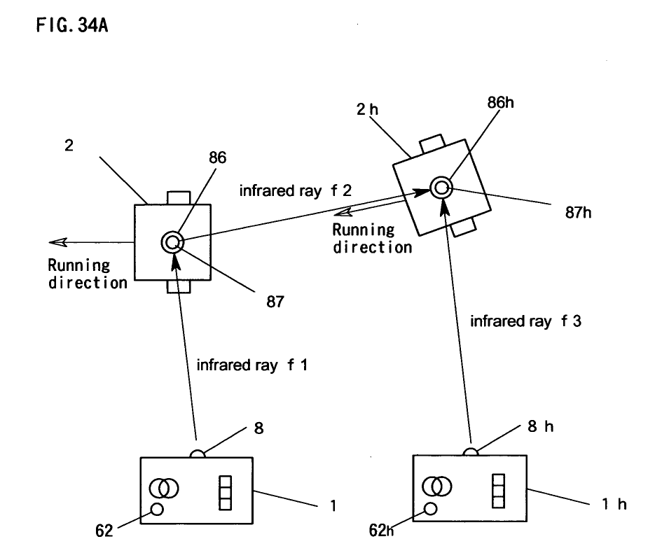

It is possible to perform more complicated remote control, such as causing a plurality of running objects to follow one another by adding a radio signal-transmitting function thereto. In FIG. 34, the controller 1 is controlling a running object 2g. The running object 2g has a light emitting element 87a, from which control signals are sent to a light receiving element 86b of a running object 2h. The running object 2h, in turn, sends control signals from a light emitting element 87b to a light receiving element 86c of a running object 2e. In this way, a single controller 1 allows the player to control the three connected running objects 2g, 2h, 2i, as if controlling a snake. It is assumed, however, that the respective running objects have addresses which are different from one another, and the timings with which signals are sent out are made different from one another by one, as shown in FIG. 35. Further, the respective running objects are sending a control signal in such a direction that the target orientation is returned thereto. In addition, by controlling the speed such that the signal strength is held to within a certain value in order to prevent the running objects from hitting one another, the running objects are caused to run in line with one another.

Further, by operating the switches of the controller 1 for sending various commands to the running objects to stop or change the control signals sent from the running objects, it is possible to perform a variety of controls, such as disconnecting the running objects and changing the formations thereof, which allows interesting game machines and toys to be created.

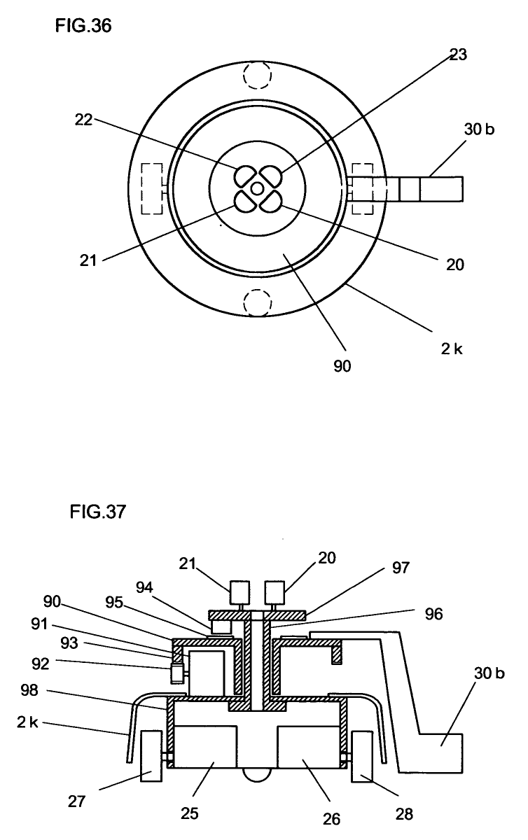

When the arms or some other portion of a ball game machine, fighting game machine, or the like are to be controlled in addition to the running control, the controllability will be improved if the orientations thereof can be set independently of the running direction. An embodiment of running object 2k for a hockey game is shown in FIG. 36, a top view, and in FIG. 37, a side sectional view.

In FIG. 37, a geared motor 25, 26 that drives a wheel 27, 28 is fixed to a main chassis 98, and a sensor substrate 97 is fixed to the main chassis 98 through a pipe 96. The sensor substrate 97 is provided with a light receiving element 20, 21, 22, 23 and an optical rotary encoder main body 94. A working base 90 is provided such that it can be able to be turned about the pipe 96. A gear 93 is attached to the working base 90 on the circumference, and is engaged with a pinion gear 92 of a motor 91 for turning the base that is mounted on the main chassis. Further, the working base 90 is provided with a striped reflector, which constitutes an angle detector 200, being combined with an optical rotary encoder main body 94. In addition, a stick 30b for hitting a ball is fixed to the working base 90.

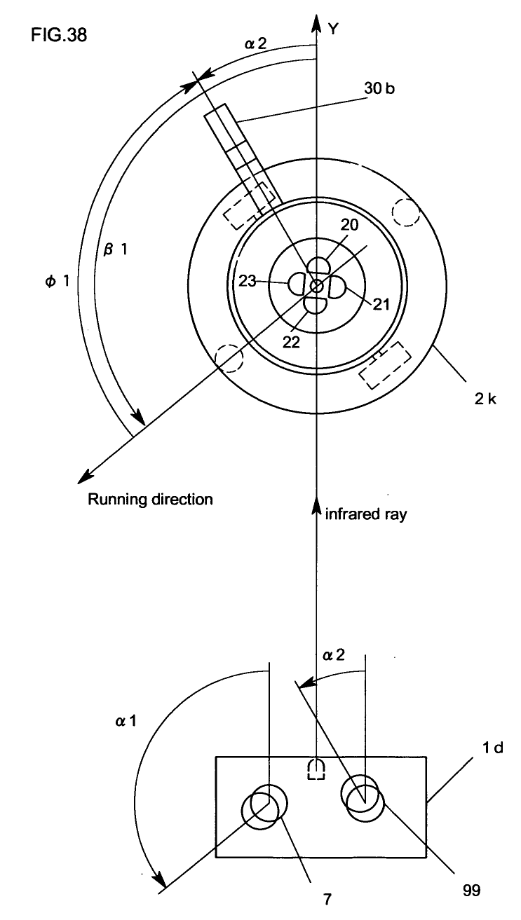

The running object 2k thus configured is used together with a controller 1d having two joysticks 7 and 99, as shown in FIG. 38. The joystick 7 is for run control, and the direction in which the joystick 7 is thrown down is send out as a running target orientation signal α1. The joystick 99 is for stick control, and the direction in which the joystick 99 is thrown down is sent out as a stick target orientation signal a 2. When the running object 2k receives these radio control signals, the main chassis portion operates in the same way as previously described, running in the direction in which the joystick 7 is thrown down.

The rotational movement of the working base will be described here. In FIG. 38, when a radio control signal enters the running object 2k, the incoming direction is detected, and thereby the orientation angle β1 of the running object 2k is determined. Because the target orientation angle α2 of the stick has been received, the relative angle of the working base 90 with respect to the main chassis 98 must meet φ1=α2−β1 in order to direct the stick toward the target orientation. In other words, if the relative angle of the working base 90 obtained by an angle detector 200 is φ, driving the motor for turning the base, 91, using φ1−φ as an error angle results in φ1−φ=0, i.e., φ=α2−β1 through the feedback control. Thus, the stick 30b is directed toward the orientation specified with the joystick 99 of the controller 1d. In this way, it is possible to intuitively control the orientation of the stick independently of the running direction with the use of the joystick 7.

Depending upon the application, it is possible to attach various articles to the working base 90, which can be controlled freely and intuitively, for creating useful running objects. For a game machine, for example, attaching a gun to it provides a shooting game machine, and attaching various weapons provides a combat game machine or a fighting one.

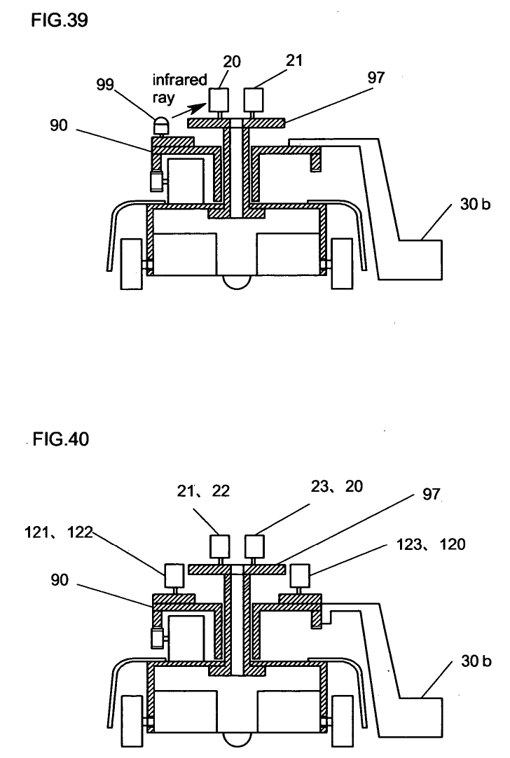

FIG. 39 and FIG. 40 illustrate embodiments which employ different methods for detecting the angle of the working base. FIG. 39 is a side sectional view of a running object having infrared light emitting elements for angle detection on the working base side. By causing infrared ray to be emitted with a timing that will not affect the run control, it is possible to detect the relative angle between the main body and the working base. FIG. 40 illustrates an embodiment in which a second light receiving element 120, 121, 123, 124, 123 for detecting incoming direction is provided on the working base 90 to allow direct detection of the orientation of the working base 90.

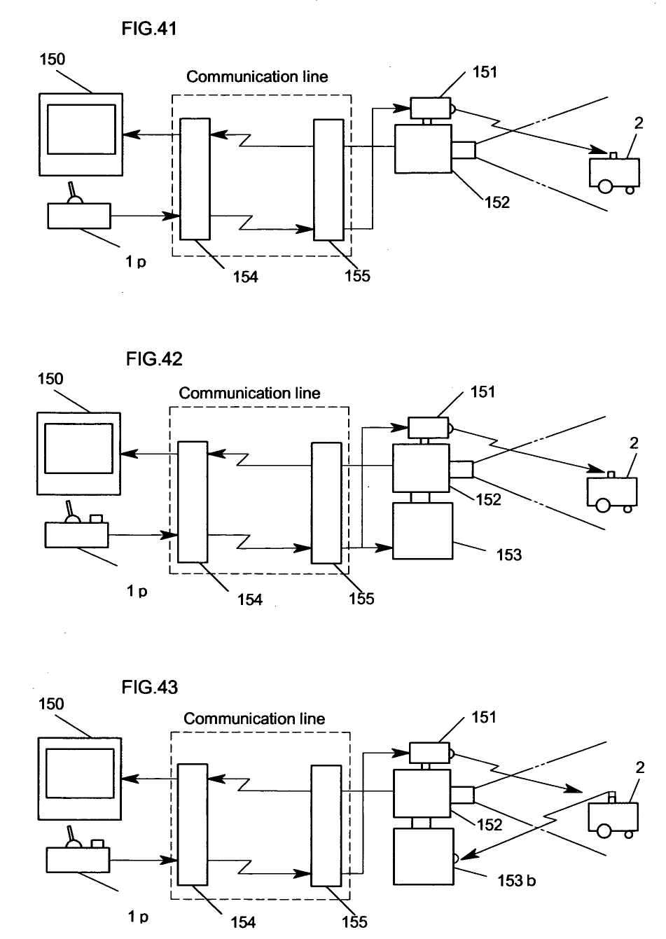

To control a running object 2 in a far place, a communication line is used. Although wiring can be used for a running object 2 in a relatively near place, the internet line or the like is used for a running object 2 in a remote place. FIG. 41 illustrates an embodiment in which a communication line is used. Basically, a controller 1p and a television receiver 150 are provided on the player side, and control signals from the controller 1p are transmitted over a communication line through an interface device 154, such as a personal computer. Alternatively, a mobile phone with a television function can be used. In the location where the running object 2 is provided, the control signals which pass through an interface devices 155 again and a control relay 151 are sent out as radio control signals. At the same time, the radio signals for detecting the incoming direction are sent out. Images of the movements of the running object 2 are taken by a television camera 152 and transmitted. The images pass through the same route as that previously described and are displayed on the television receiver in front of the player. It is important that the control relay 151 and the television camera 152 be positioned close to each other, because, when this requirement is met, the position of the control relay 151 recognized by the running object 2 coincides with the line of vision of the television camera, and the image created from such positional relationship being displayed on the television receiver 150 allows the player to control the running object 2 as if he controlled it on the spot. Preferably, the television camera 152 and the control relay 151 are positioned one upon another, and fixed to each other such that the optical axes thereof substantially coincide with each other. This assures that strong radio signals are always delivered in the direction toward which the television camera is directed, and that the error for line of vision is small. Further, because there is no need for control about any area which is not displayed on the television receiver, radio signals that have as high a directivity as that of the television camera can be used. Therefore, a running object in a remote place can be controlled with less electric power.

Further, this system is effective against delays in communication lines. With conventional remote control systems, a delay in the communication line causes the image to be delayed with respect to the control, therefore, if the image is viewed, and then the steering is corrected to change the orientation, the actual state to be changed will have got worse, and the signal for correcting such situation will be delivered to the running object, being still more delayed, thus control is extremely difficult.

With this system, the player can input the orientation to be taken by the running object 2 in the future from the controller 1p, while viewing the image, therefore only the image is delayed, and the control itself is not difficult. It can be said that the orientation control is being performed real time by the running object 2 itself on the spot.

FIG. 42 illustrates an embodiment in which the orientation of the television camera is remotely controlled. The controller 1p is operated to control both the running object 2 and a television camera orientation changer 153. Alternatively, the zoom lens of the television camera 152 is also operated.

FIG. 43 illustrates an embodiment in which a television camera orientation changer 153b performs automatic tracking on the signals received from the running object 2. In this case, the player can concentrate on controlling the running object 2.

The system as shown in FIG. 41 can be adapted such that a number of controllers 1p and television receivers, and running objects 2 as many as the controllers 1p are provided, and each running object 2 can be controlled with the corresponding controller 1p and television receiver. In this case, one set of a television camera 152 and a control relay 151 is used in the multiple mode. Or, if a number of systems as shown in FIG. 42 or FIG. 43 are provided, the running objects being in the same place, it is possible to create a communication line-based, remote-controlled match game using the internet in which a plurality of people can participate. In addition, people in the same hall can participate in the game, controlling the running objects through the controller 1 without using the internet, or directly through the controller 1.

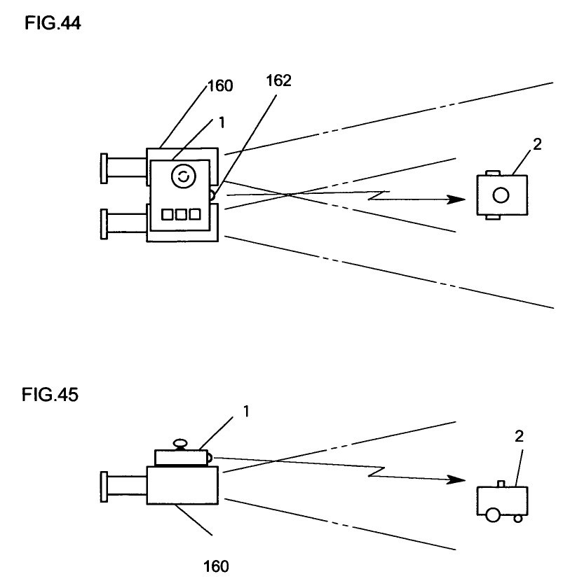

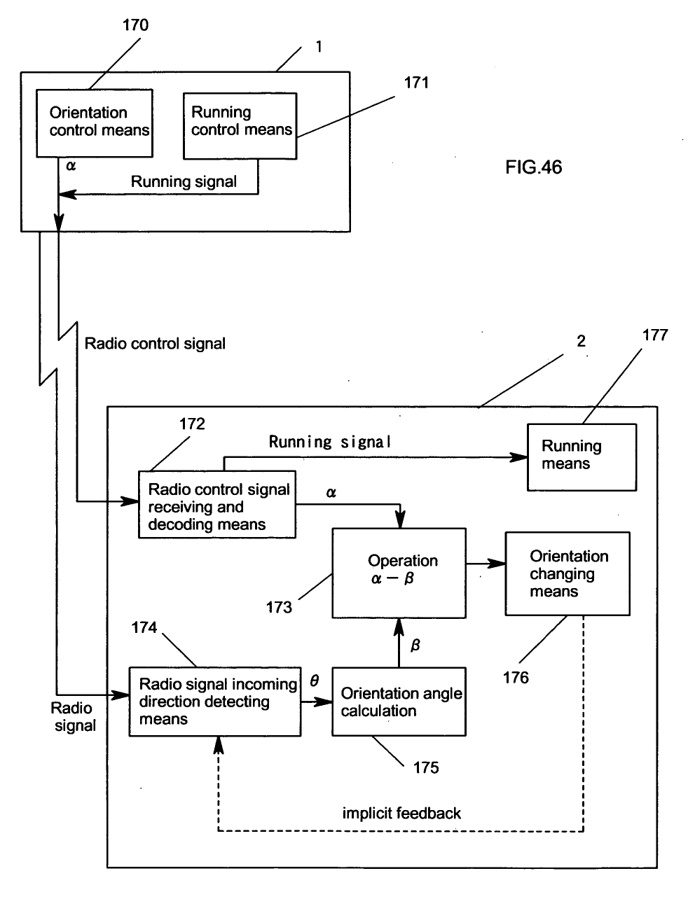

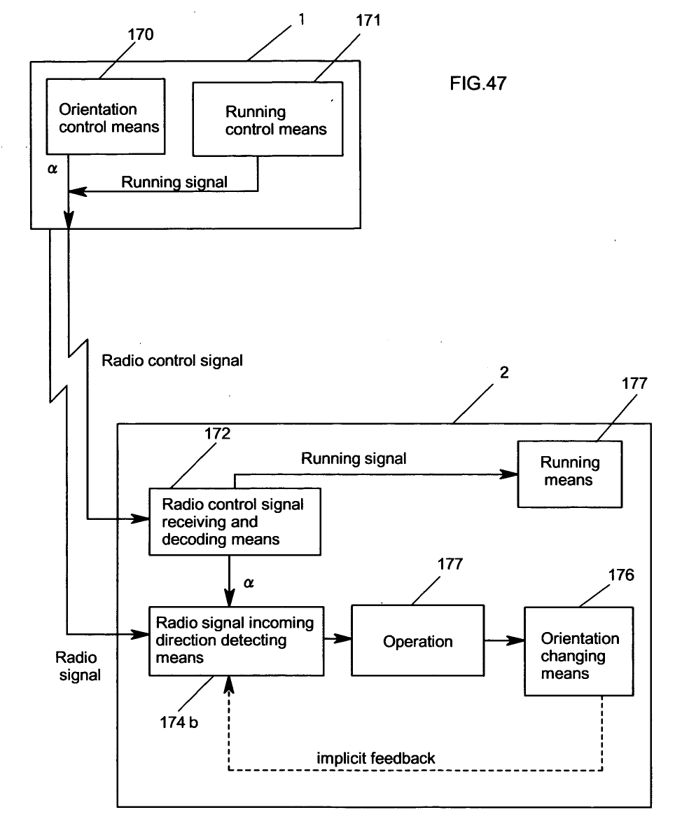

FIG. 44 is a top view and FIG. 45 is a side view of an embodiment in which control is performed with a combination of a controller land binoculars 160. This embodiment is characterized in that, by combining the controller 1 with binoculars 160, a running object 2 in a remote place can be viewed well in controlling it, and by attaching a lens 162 to the controller 1 in front of the infrared light emitting elements, the signal directivity can be improved, resulting in the strength being maintained even if the running object 2 is in a remote place. This embodiment is based on the concept that the running object should be controlled only in the area that can be seen with binoculars.

The binoculars as mentioned in the above description may be replaced with a telescope or a video camera equipped with a telephoto lens.

### INDUSTRIAL APPLICABILITY

The present invention is intended to make it possible to remotely control a running object with ease, and can be applied in various fields.

First, the fields of hobby and toy including running model, with which a number of remote-controlled products have been created up to now, can be mentioned, and in these fields, the present invention, which has a feature of easy operation, allows creation of products giving an image different from the conventional one. In particular, the present invention, having a function of causing a running object to follow the controller, is suitable for such applications as control of pet robots. In addition, the present invention is practically independent of the running means itself, thus it is applicable to virtually any running objects that have capabilities of changing the run and orientation, such as walking-type robots and articulated insect-type robots.

Further, a number of video game machines have been produced, being in wide spread use, and the present invention allows the running object to be easily controlled with a controller equipped with a joystick similar to that of the video game machine, thus the game which has been capable of being played only with a video game machine can now be played as a mechanical game in the real world.

The present invention can be applied to create electric carriers by utilizing the feature of causing the running object to follow a person carrying the controller in front or back of him or her, while keeping a constant distance, and the feature of allowing free and easy control. Thus, the present invention is also suited to create golf club caddy carts, agricultural carrier vehicles, and the like.

A number of conventional robots for use in dangerous works or the like are provided with a built-in television camera, and are controlled based on the images transmitted from the television camera as radio signals. For such works, the present invention can be applied to create small, robust, and low-cost robots.

The running object according to the present invention can be used as an aid for handicapped people in the following way. For example, wagon cars or the like for use as storage, electrically operated shelves, electrically operated desks, wheelchairs, and other various articles are adapted to be remotely controlled. If each article is provided with a unique address, any user having a controller provided with the address-selecting capability at hand can fetch any desired object to near him or her as required, with no need for walking. When the fetched object is no longer necessary, the user can put it away, again without the need for walking. Such aid can be put into practice use because of the feature of easy control.

By using a communication line, a television camera, and a television receiver, it is made possible to control a running object in an extremely remote place. This allows internet-based games, works in remote, unattended places, and works in dangerous places to be carried out. Further, if a television camera and a control relay are installed in the necessary room in the home, plants can be remotely supplied with water, pets can be remotely fed, and the player can play about with pets through the robot. These applications involve remote-controlling of a home robot, however, if the system is connected with a mobile television phone, a more practical system can be created.

What is claimed is:

1. A controller for controlling a running object, comprising:
orientation inputting means which is capable of specifying orientation over 360° about one axis; and
means for emitting the inputted orientation information as a radio signal.

2. A controller for controlling a running object, comprising:
orientation inputting means which is capable of specifying orientation over 360° about one axis;
means for emitting the inputted orientation information as a radio signal; and
means for emitting a signal for teaching incoming direction.

3. The controller for controlling a running object of claim 1, wherein
a telescope is provided, the optical axis being aligned with the direction in which the radio signal is emitted.

4. The controller for controlling a running object of claim 1, wherein
a television camera is provided, the optical axis being aligned with the direction in which the radio signal is emitted.

5. A controlled running object comprising:
means for determining the incoming direction for a radio signal;
means for receiving a control radio signal and decoding it to obtain a target orientation α and a running signal;
assuming that the orientation of main body calculated using said incoming direction as reference is β, computing (α−β) to drive orientation changing means; and
driving running means in accordance with the running signal.

6. A controlled running object comprising:
means for determining the incoming direction for a radio signal;
means for receiving a control radio signal and decoding it to obtain a target orientation α and a running signal;
assuming that the orientation of main body calculated using said incoming direction as reference is β, computing (α−β) to drive steering means; and
driving running means in accordance with the running signal.

7. A controlled running object comprising:
a plurality of radio signal receiving elements having a directional characteristic that are disposed, orientation being changed;
means for reading the signal levels from these radio signal receiving elements and carrying out computation to determine the incoming direction for a radio signal;
means for receiving a control radio signal and decoding it to obtain a target orientation α and a running signal;
assuming that the orientation of main body calculated using said incoming direction as reference is β, computing (α−β) to drive steering means; and
driving running means in accordance with the running signal.

8. The controlled running object of any one of claims 5, 6, and 7, wherein means for emitting a radio signal is provided.

9. The controlled running object of any one of claims 5, 6, and 7, wherein means for determining the incoming directions for two or more radio signals is provided.

10. A controlled running object comprising:
an incoming direction detector which is capable of controlling the directional characteristic of a received radio signal by means of a control signal;
means for receiving a control radio signal and decoding it to obtain a control signal;
changing the directional characteristic of said incoming direction detector by means of said control signal; and
computing the output of said incoming direction detector to drive an orientation changing means for causing feedback control for orientation to be carried out and causing running operation to be carried out in accordance with control signal data.

11. The controlled running object of any one of claims 5, 6,
a control relay which receives the data and emits it as a radio signal;
a television camera installed in the vicinity of it;
transmitting the image signal through a transmission line;
installing a television receiver for receiving the signal and regenerating the image in the vicinity of said controller.

15. A controlled running object comprising:
means for changing orientation;
means for running;
means for receiving a control radio signal and decoding it to obtain a control signal;
means for receiving a radio signal to detect the incoming direction;
means for using the incoming direction as reference for changing the orientation in accordance with the control signal and running; and
when a control signal including a run command for target orientation α is received, assuming the orientation of the main body obtained by carrying out computation on the basis of said incoming direction is β, and when the difference between α and β is larger than the specified value, changing the orientation in the direction which reduces the difference between α and β, until the difference between α and β is reduced.

16. A controlled running object comprising:
means for changing orientation;
means for running;
means for receiving a control radio signal and decoding it to obtain a control signal;
means for receiving a radio signal to detect the incoming direction;
means for using the incoming direction as reference for changing the orientation in accordance with the control signal and running; and
correcting the computed difference between the target orientation α included in said control signal and the and 7, comprising:
a working table which is pivoted above a main body, and is connected to the main body with turning drive means;
means for determining the second radio signal incoming direction, being installed on the working base; operating second radio signal incoming direction data obtained therefrom and control signal data to drive said turning drive means, causing feedback control for orientation of the working base to be carried out, and causing working base orientation control to be carried out in accordance with control signal data.

12. The controlled running object of any one of claims 5, 6, and 7, comprising:
a working table which is pivoted above a main body;
turning drive means between the main body and said working table;
means for detecting the turning angle between the main body and said working table;
operating the detected turning angle, radio signal incoming direction data, and control signal data to drive the turning drive means, causing feedback control for orientation of the working base to be carried out, and causing working base orientation control to be carried out in accordance with control signal data.

13. A control relay for controlled running object, comprising:
means for receiving a control signal;
means for emitting the received control signal as a radio signal; and
means for emitting a radio signal for teaching incoming direction.

14. A remote control system for controlled running object, comprising:
a controller equipped with orientation inputting means which is capable of specifying orientation over 360° about one axis;
transmitting a signal from the controller through a communication line;
orientation β obtained from the incoming direction to expand it to a value exceeding 360° for determining the amount of drive to drive the orientation changing means.

17. A controlled running object comprising:
means for receiving a control radio signal and decoding it to obtain a control signal;
means for receiving a radio signal to detect the incoming direction;
means for using the incoming direction as reference for changing the orientation in accordance with the control signal and running; and
when, in the running stopped status, the absolute value of the difference between the target orientation α included in said control signal and the current orientation β obtained on the basis of said incoming direction is close to 0, moving from the running stopped status to the forward running status, and when the absolute value of said difference is close to 180°, moving from the running stopped status to the backward running status.

18. A remote control system which combines the controller of claim 1 with the controlled running object of anyone of claims 5, 6, and 7.

19. A light incoming direction sensor comprising:
four light receiving elements which light receiving semiconductor surface is covered with a light permeating resin material having a smooth convex surface; and
the orientations of any two adjacent ones of these four light receiving elements being different by 90°.

20. A light incoming direction detector comprising:
a plurality of light receiving elements disposed with the orientations thereof being made different from one another;
a circuit for selecting the signal from these light receiving elements;
a variable amplifier for amplifying to an appropriate level;
means for reading the signal level; and
computing the levels of the signals from a plurality of light receiving elements to determine the light incoming direction.
